(19) United States
(12) Patent Application Publication
(10) Pub. No.: US 2016/0010809 A1
(43) Pub. Date: Jan. 14, 2016

(54) LIGHTING APPARATUS

(71) Applicant: Carlotta Francesca Isolina Maria DE BEVILACQUA, Milano (IT)

(72) Inventor: Carlotta Francesca Isolina Maria DE BEVILACQUA, Milano (IT)

(21) Appl. No.: 14/669,734

(22) Filed: Mar. 26, 2015

(30) Foreign Application Priority Data
Mar. 28, 2014 (IT) MI2014A000548

(51) Int. Cl. F21K 99/00; F21V 7/04; F21V 29/83; F21V 7/06

(52) U.S. Cl. CPC F21K 9/50; F21V 7/06; F21V 7/045; F21V 29/83; F21Y 2101/02

(57) ABSTRACT

A lighting apparatus comprises a light engine, having a LED light source and an emission exit aligned along an axis, and a reflector, which extends along and about the axis and has a front surface facing the light engine and a rear surface opposite to the front surface; the reflector faces the emission exit of the light engine and has an exit opening opposite to the emission exit; the emission exit faces an axial top of the reflector and the reflector comprises a dome-shaped body made of a transparent material, for example PMMA, and shaped so as to reflect the light exiting from the emission exit toward the exit opening.

The present invention relates to a lighting apparatus, in particular a LED lighting apparatus.

### BACKGROUND OF THE INVENTION

Various lighting apparatuses are known in the ambient lighting field (indoor and outdoor lamps), which however appear to have margins for improvement, in particular in terms of construction simplicity, efficiency and photometric performance.

The apparatuses employing LED light sources especially may have problems related to light beam distribution as well as to effective dissipation of the heat generated by the light sources.

### SUMMARY OF THE INVENTION

It is thus an object of the present invention to provide a lighting apparatus which is simple to be implemented and is fully effective, having in particular high efficiency, high possibilities of defining the light supplied by the lighting apparatus, and good heat dissipation capabilities.

The present invention thus relates to a lighting apparatus as defined in essential terms in appended claim 1, the additional features of which are disclosed in the dependent claims.

The lighting apparatus of the invention is simple to be implemented and fully effective, since it has in particular high efficiency, high possibilities of defining the light supplied by the apparatus, and good heat dissipation capabilities.

### BRIEF DESCRIPTION OF THE DRAWINGS

Further features and advantages of the present invention will become apparent from the following description of a non-limitative embodiment thereof, with reference to the accompanying drawings, in which:

FIG. 1 is a diagrammatic side elevation view of a lighting apparatus according to the invention;

FIG. 2 is a diagrammatic perspective bottom view, with parts removed for clarity, of the lighting apparatus in FIG. 1;

FIGS. 3 and 4 are perspective views on enlarged scale, from the top and from the bottom respectively, of a detail of the lighting apparatus in FIG. 1;

FIG. 5 is a partially exploded, diagrammatic longitudinal section view, with parts removed for clarity, of the lighting apparatus in FIG. 1;

FIG. 6 is a view on enlarged scale of the detail highlighted in FIG. 5, taken along the plotting plane VI-VI;

FIG. 7 is a side view of a component of the lighting apparatus according to the invention.

### DETAILED DESCRIPTION OF THE INVENTION

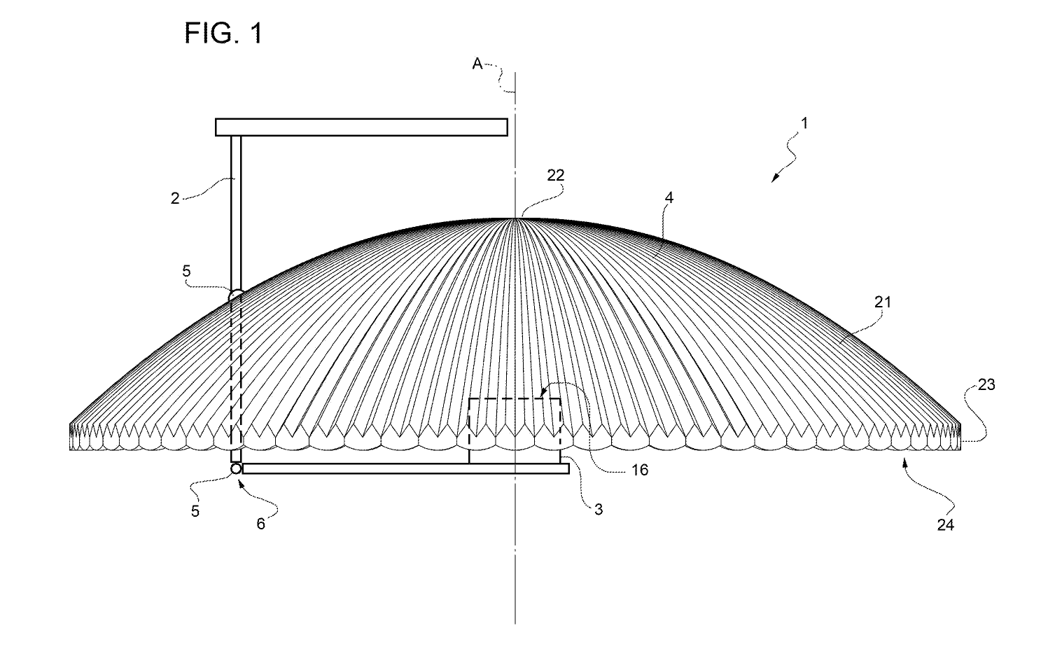

In FIG. 1, reference numeral 1 indicates as a whole a lighting apparatus, in particular a LED lighting apparatus, mainly comprising a support structure 2, a light engine 3 and a reflector 4.

By way of mere example, the lighting apparatus 1 shown in FIG. 1 is a ceiling or wall lamp; it is understood that the lighting apparatus 1 may be used in other configurations as it may be provided with a support structure 2 shaped so as to form, for example, a suspension lamp, a desk lamp, a floor lamp, etc.

The support structure 2 supports the light engine 3 and the reflector 4 in a predetermined mutual position.

The support structure 2 optionally includes joints 5 which allow the relative movement between the light engine 3 and the reflector 4.

In particular, the light engine 3 is connected to an articulated system 6, which allows the rotation of the light engine 3; optionally, reflector 4 is also adjustable with respect to the support structure 2.

The support structure 2 supports the light engine 3 and the reflector 4; the light engine 3 and the reflector 4 extend and are aligned along an axis, A which in this case is also an optical axis of the lighting apparatus 1.

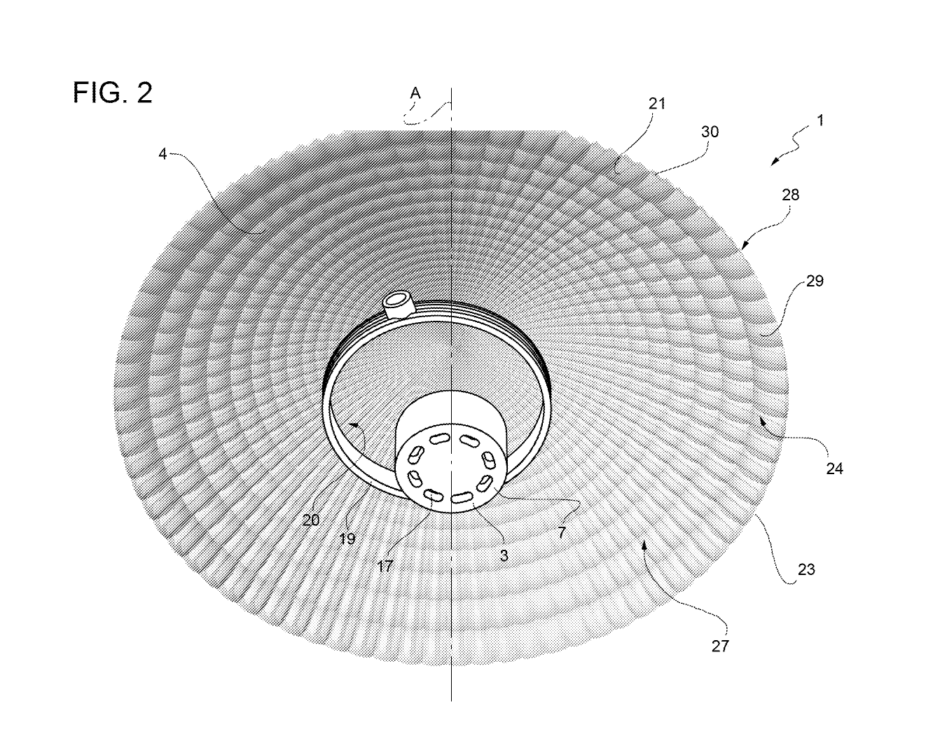

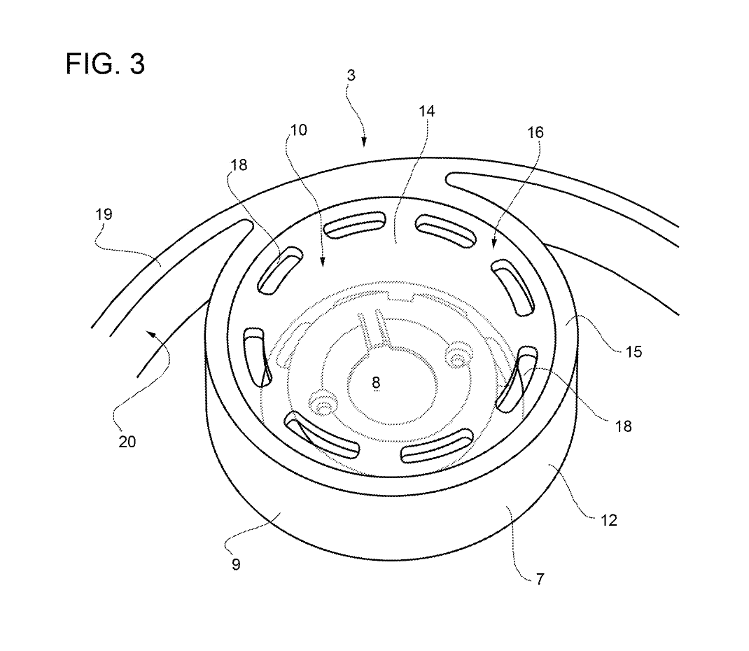

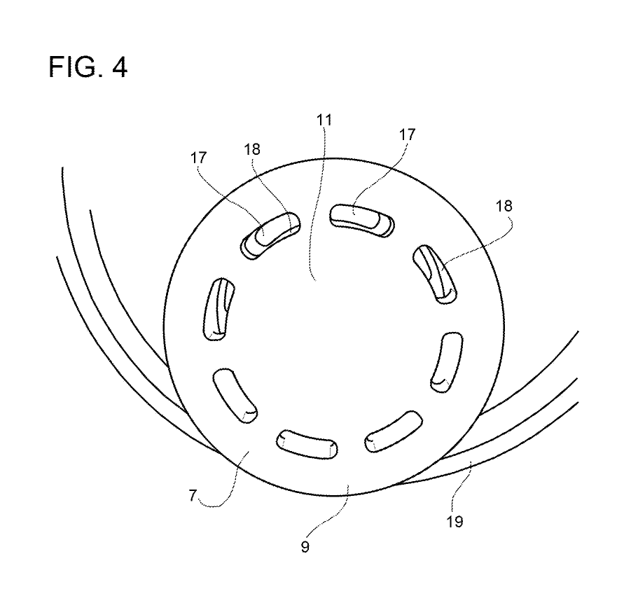

Also with reference to FIGS. 2-5, the light engine 3 comprises a hollow body 7 which houses a light source 8, precisely a LED light source, and also acts as a heat sink, since it is made of a heat conducting material, e.g. aluminum.

Body 7 may be shaped in various manners; in the example shown, body 7 has a core 9, for example substantially cylindrical along axis A, provided with an internal mixing chamber 10, where the light source 8 is placed.

Chamber 10 is delimited by a bottom wall 11, which is substantially perpendicular to axis A and on which the light source 8 is mounted, and by a side wall 12, which is for example substantially cylindrical and projects from a peripheral edge of the bottom wall 11 and is arranged about axis A.

The side wall 12 is preferably internally coated (toward chamber 10) with a white paint having a very high reflectance.

The light source 8, which may comprise one or more LEDs fixed onto a LED holder board, is mounted on an inner face of the bottom wall 11, facing chamber 10.

Chamber 10 is closed, at an axial end opposite to the bottom wall 11, by a satin-finished, transparent 14 disc, for example made of PMMA, surrounded by a peripheral end edge 15 (an opaque edge which is not transparent to light, in this case made of the material of body 7) of body 7 and precisely of the side wall 12.

Disc 14 defines an emission exit 16 of the light engine 3; the light engine 3 has a substantially hemispheric emission, exiting from the emission exit 16.

Body 7 is provided with a plurality of through cooling openings 17, 18, which extend so as to be substantially parallel to axis A and are arranged about axis A.

For example, body 7 comprises a first series of openings 17 obtained through the bottom wall 11 and consisting of respective slots angularly spaced apart with respect to one another; and a second series of openings 18 obtained through disc 14 and aligned to respective openings 17.

Core 9 is joined to an eccentric peripheral ring 19 which projects from core 9 and is connected to the supporting structure 2, preferably by means of the articulated system 6. A further cooling opening 20 is defined between core 9 and ring 19.

The light source 8 and the emission exit 16 are aligned along axis A.

Reflector 4 extends along and about axis A and faces the emission exit 16 of the light engine 3 and the light source 8.

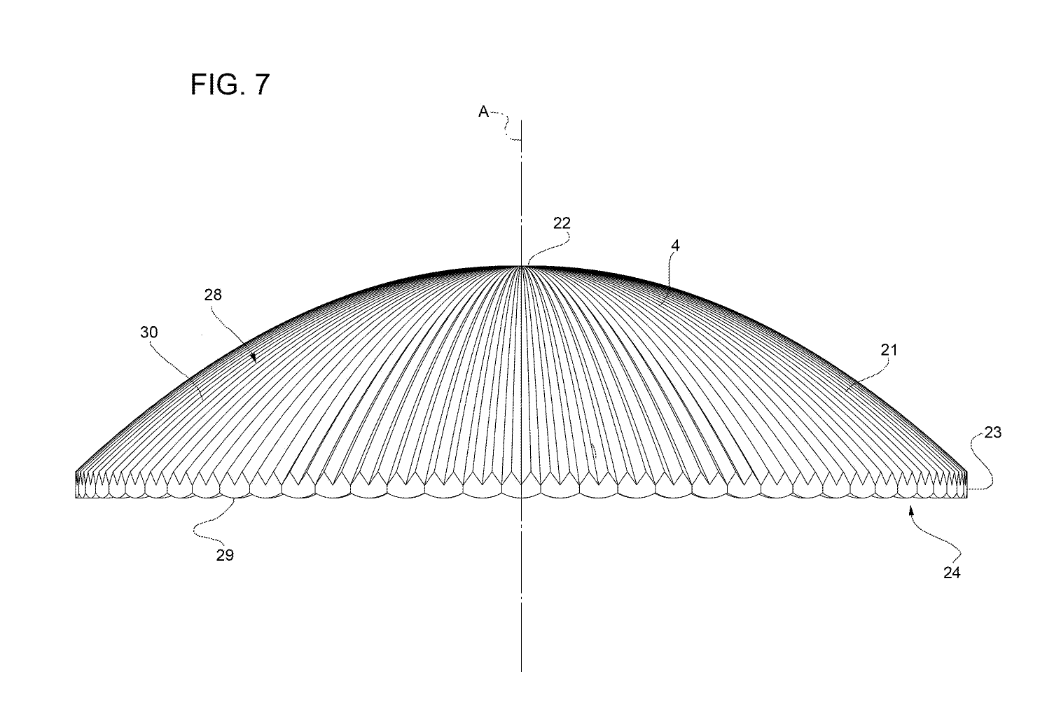

In particular, as shown in FIGS. 1-2 and 5-7, reflector 4 comprises (or consists of) a dome-shaped body 21 made of a transparent material, such as PMMA, which extends along axis A between an axial end 22, placed along axis A in front of the emission exit 16 of the light source 3, and an annular peripheral edge 23 which delimits an exit opening 24 of reflector 4.

In particular, reflector 4 is shaped as a rotation paraboloid, having a parabolic longitudinal section, and the emission exit 16 of the light engine 3 is placed in the focus of the paraboloid.

The emission exit 16 and the exit opening 24 are mutually opposite (i.e. the light emitted by the light source 8 transits through the emission exit 16 and through the exit opening 24 in opposite directions).

Reflector 4 has a front surface 27, facing the light engine 3, and a rear surface 28, opposite to the front surface 27.

The front surface 27 is a concave surface on which spherical caps 29 defining respective optical portions are present.

In particular, the front surface 27 has a pattern of spherical caps 29 projecting toward the light engine 3 and arranged so as to be circumferentially and longitudinally side-by-side on the front surface 27.

The spherical caps 29 are organized in concentric circles about axis A and on rows arranged along respective generatrices of reflector 4.

The rear surface 28 is knurled; in particular, the rear surface 28 is provided with a series of projections 30 shaped to operate in total internal reflection and to reflect, toward the exit opening 24, substantially all (or most of) the emission of the light engine 3 entering body 21 through the front surface 27.

The projections are preferably longitudinally arranged side-by-side and extend along respective generatrices of reflector 4.

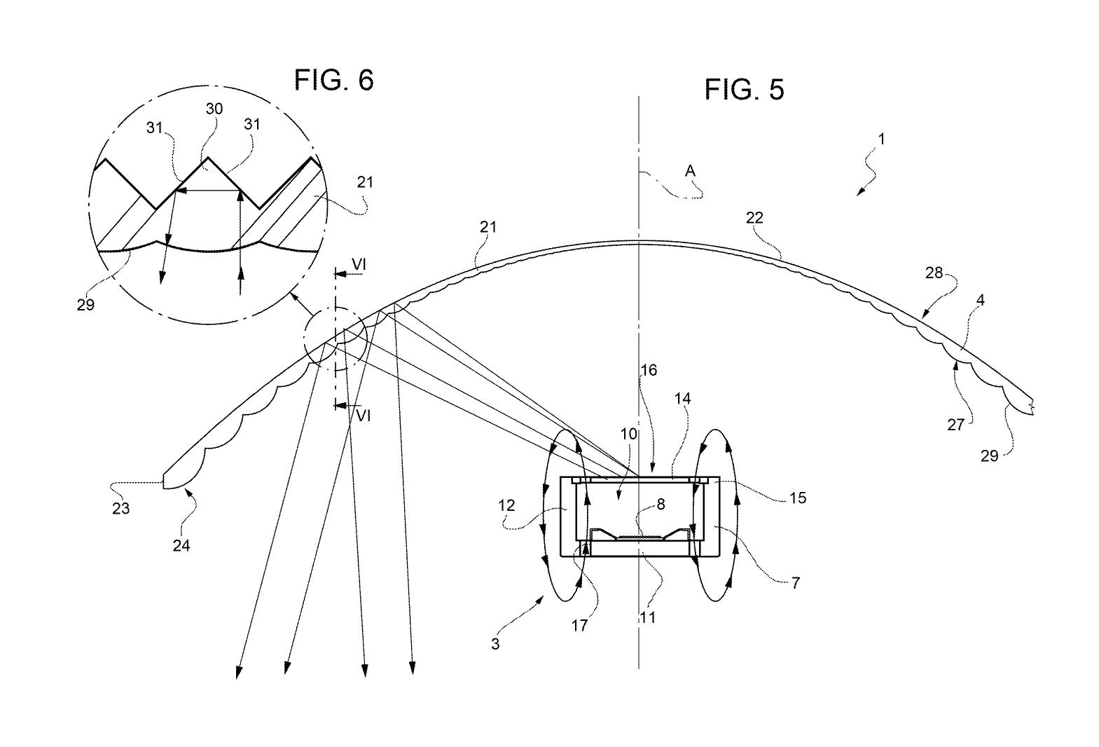

Each projection has two sides 31 converging into a vertex, in particular by about 90° (FIG. 6).

In use, the light emitted by the light source 8 is mixed and uniformed in chamber 10 and diffused through disc 14; the emission of the light engine 3 exits from the emission exit 16 with a substantially hemispheric distribution and is incident upon the front surface 27 of reflector 4.

The light enters into the reflector body 21 through the front surface 27 and is reflected by the rear surface 28. In each projection 30, the light rays which are incident on each side 31 are internally reflected on the other side 31 and from there go back, through body 21, to the front surface 27.

The spherical caps 29 define the optical light exiting properties. It is understood that optical portions of different geometry could be used instead of the spherical caps.

Since body 21 is made of a transparent material, a light effect is determined, in which body 21 is illuminated instead of simply reflecting the light as in the common reflectors.

The light is concentrated, with part of the light emitted in an indirect mode.

The cooling openings 17, 18, 20 allow the flows of cooling air to circulate through chamber 10 and the light rays reflected by reflector 4 to pass therethrough.

In a variant, the front surface 27 is a reflecting mirror surface, e.g. aluminum coated.

In this case, the light emitted by the light engine 3 does not enter into the body 21 of reflector 4, but is directly reflected by the front surface 27.

A highly controlled lighting is obtained.

In a further variant, the front surface 27 is coated with a white paint having a high reflectance in order to generate a diffused light effect.

Finally, it is understood that further changes and variations can be made to the lighting apparatus described and shown herein, without departing from the scope of the appended claims.

1. A lighting apparatus (1) comprising a light engine (3), having a LED light source (8) and an emission exit (16) aligned along an axis (A), and a reflector (4), extending along and about the axis (A) and having a front surface (27) facing towards the light engine (3) and a rear surface (28) opposite to the front surface (27); the reflector (4) facing the emission exit (16) of the light engine (3) and having an exit opening (24) opposite to the emission exit (16); the lighting apparatus (1) being characterized in that the emission exit (16) faces an axial top of the reflector (4) and the reflector (4) comprises a dome-shaped body (21) made of a transparent material, for example PMMA, and shaped so as to reflect the light exiting from the emission exit (16) toward the exit opening (24).

2. A lighting apparatus according to claim 1, wherein the light engine (3) has substantially hemispheric emission.

3. A lighting apparatus according to claim 1, wherein the reflector (4) has the shape of a rotation paraboloid, having a parabolic longitudinal section.

4. A lighting apparatus according to claim 3, wherein the emission exit (16) of the light engine (3) is positioned in a focus of the paraboloid.

5. A lighting apparatus according to claim 1, wherein the rear surface (28) of the reflector (4) is knurled.

6. A lighting apparatus according to claim 5, wherein the rear surface (28) is provided with a series of projections (30) shaped to operate in total internal reflection and reflect towards the exit opening (24) substantially the whole emission of the light engine (3) entering the dome-shaped body (21) through the front surface (27).

7. A lighting apparatus according to claim 6, wherein the projections (30) are arranged longitudinally side-by-side.

8. A lighting apparatus according to claim 6, wherein the projections (30) extend along respective generatrices of the reflector (4).

9. A lighting apparatus according to claim 1, wherein the front surface (27) of the reflector (4) is a concave surface provided with a plurality of projecting spherical caps (29) defining respective optical portions.

10. A lighting apparatus according to claim 9, wherein the front surface (27) has a pattern of spherical caps (29) projecting towards the light engine (3) and arranged circumferentially and longitudinally side-by-side on the front surface (27).

11. A lighting apparatus according to claim 10, wherein the spherical caps (29) are arranged in concentric circles about the axis (A) and in rows set along respective generatrices of the reflector (4).

12. A lighting apparatus according to claim 1, wherein the light engine (3) comprises a body (7) housing the LED light source (8) and acting also as heat sink, being made of a heat conductive material; the body (7) being provided with through cooling openings (17, 18) positioned substantially parallel to the axis (A) for allowing both circulation of cooling air and passage of light rays reflected by the reflector (4).

13. A lighting apparatus according to claim 12, wherein the body (7) comprises a core (9) housing the LED light source (8) and joined to an eccentric peripheral ring (19) projecting from the core (9) and connected, preferably via an articulated system (6), to a support structure (2).

14. A lighting apparatus according to claim 12, wherein the body (7) is a hollow body having an internal mixing chamber (10), housing the LED light source (8) and having a high reflectance white coated lateral wall (11) and closed by a satin transparent disc (14) defining the emission exit (16).
